(19) United States
(12) Patent Application Publication
(10) Pub. No.: US 2002/0117383 A1
(43) Pub. Date: Aug. 29, 2002

(54) Tray accommodation unit

(76) Inventor: Toshiyuki Tezuka, Tokyo (JP)

Correspondence Address: FLYNN, THIEL, BOUTELL & TANIS, P.C., 2026 Rambling Road, Kalamazoo, MI, 49008-1699, US

(21) Appl. No.: 10/071,806

(22) Filed: Feb. 7, 2002

(30) Foreign Application Priority Data
Feb. 26, 2001 (JP) 2001-50422

(51) Int. Cl. B65G 47/10

(52) U.S. Cl. 198/890

(57) ABSTRACT

There is provided a tray accommodation unit having a simple construction capable of restraining the increase of a manufacturing cost, and being excellent in maintenance and installing workability. The tray accommodation unit comprises multiple tray accommodation sections arranged in parallel with each other in a horizontal direction, each tray accommodation section having an opening at the upper portion through which multiple trays can be accommodated in a stacked state, a holding unit for holding the trays, and a moving unit for movably supporting the holding unit in horizontal and vertical directions, wherein the holding unit is engaged with the inside of each tray accommodation section through the opening by the moving unit.

### BACKGROUND OF THE INVENTION

1. Field of the Invention

The invention relates to a tray accommodation unit having multiple trays on which devices such as an integrated circuit (IC) and the like can be placed.

2. Description of the Related Art

In a horizontal conveyance type autohandler for assorting ICs while connecting to an IC tester, multiple ICs are placed on a tray, and the ICs are transferred from the tray or tested ICs are transferred to a vacant tray for assortment. Further, it is also effected that a vacant tray to which the ICs are transferred is moved to a tray for assortment. The autohandler controls the conveyance of the tray in a tray accommodation unit. FIG. 4 shows a conventional tray accommodation unit having multiple trays on which ICs can be placed. As shown in FIG. 4, a tray accommodation unit SJ comprises a stocker 40 for supply purpose, first to third stockers 41 to 43 for accommodation purpose, and a vacant stocker 44. These stockers have accommodate therein multiple trays respectively.

Each of the stockers 40 to 44 has an elevating unit 51 which holds trays from the lower portion thereof, i.e. in the ascending order and is capable of elevating, and a stocker holding mechanism 52 for holding the tray which was elevated at the uppermost portion thereof by each elevating unit 51. The tray accommodation unit SJ has a holding unit 53 for sucking the upper surface of the tray and holding it and a horizontal movement mechanism 54 for movably supporting the holding unit 53 in a horizontal direction. The holding unit 53 is provided to engage with each stocker holding mechanism 52 and conveys the trays between respective stocker holding mechanisms 52 of the stockers 40 to 44.

Multiple trays T₀ on which multiple ICs to be tested by an IC tester, not shown, are placed are accommodated in the stocker 40. The trays T₀ on which the ICs are placed are accommodated inside the stocker 40 in a stacked state. Tray T₁, T₂ and T₃ on which the ICs, which are assorted in accordance with the result of test by an IC tester, are respectively placed are accommodated in the stockers 41, 42 and 43. For example, an IC which is decided to be non-defective by the IC tester is placed on the tray T₁ of the stocker 41 while an IC which is decided to require a re-assortment is placed on the tray T₂ of the stocker 42, and an IC which is decided to be defective is placed on the tray T₃ of the stocker 43. The vacant tray T₄ on which no IC is placed is accommodated in the stocker 44.

When the ICs placed on the tray T₀ inside the stocker 40 are conveyed to the inside of the autohandler, first, each elevating unit 51 raises the tray T₀ accommodated in the stocker 40 in a stacked state so that the tray T₀ placed on the uppermost stage is disposed on the stocker holding mechanism 52. Next, each stocker holding mechanism 52 holds the tray T₀ placed on the uppermost stage which is raised by each elevating unit 51. Thirdly, multiple ICs placed on the tray T₀ which is held by each stocker holding mechanism 52 are subsequently transferred. When the tray T₀ become vacant, the holding unit 53 is moved horizontally to engage with the vacant tray T₀ which is held by the stocker holding mechanism 52 of the stocker 40, so that the holding unit 53 sucks the upper surface of the vacant tray T₀ to hold it. The holding unit 53 holding the vacant tray T₀ moves from the stocker 40 to each stocker holding mechanism 52 of the stocker 44. The stocker holding mechanism 52 of the stocker 44 holds the vacant tray T₀ which is conveyed from the stocker 40 by the holding unit 53. When each stocker holding mechanism 52 of the stocker 44 holds the vacant tray T₀, each elevating unit 51 of the stocker 44 rises so as to receive the vacant tray T₀ from the stocker holding mechanism 52. The elevating unit 51 of the stocker 44 is lowered, upon reception of the vacant tray T₀ from the lower side, so as to accommodate the vacant tray T₀, inside the stocker 44.

Meanwhile, the IC which is decided to be non-defective is conveyed to the tray T₁ held by each stocker holding mechanism 52 of the stocker 41 and is placed thereon. The tray T₁ is raised from the inside of the stocker 44 by each elevating unit 51 of the stocker 44 and is conveyed to each stocker holding mechanism 52 of the stocker 41 by each holding unit 53. Each elevating unit 51 provided in the stocker 41 is raised to engage with the tray T₁ which is filled with the ICs and receives the tray T₁ from each stocker holding mechanism 52. Each elevating unit 51 is lowered, upon reception of the tray T₁ from the lower side, and accommodates the tray T₁ which is filled with the non-defective ICs inside the stocker 41. The operations of the stocker 42 and the stocker 43 are the same as the operation of the stocker 42, and hence the explanation thereof is omitted.

According to the conventional tray accommodation unit SJ. Since each elevating unit 51 is provided in the respective stockers 40 to 44, and hence it is complex in construction, resulting in the increase of a manufacturing cost. Further, since each elevating unit 51 provided in the stockers 40 to 44 has to be maintained, a workability of each elevating unit 51 is low when it is maintained. With the construction having each elevating unit 51 in the respective stockers 40 to 44, when the stocker is intended to be expanded, causing a problem of the increase of costs and the trouble of installing operation. Further, with the construction where the trays are arranged in each stocker in a stacked state, it is necessary to limit the number of trays to be stacked to the extent not to exceed the weight in which each elevating unit 51 can stably operate, so that the number of stacks of the trays in the stocker is limited. Still further, since the stocker for supply purpose and the stocker for accommodation purpose are respectively fixedly arranged, they lack in degree of freedom of the arrangement, causing a problem that this construction cannot cope with the increase and decrease of number of testing rods for ICs and the improvement of the disposal capacity of the autohandler cannot be improved.

### SUMMARY OF THE INVENTION

The invention has been made in view of such circumstances and it is an object of the invention to provide a tray accommodation unit capable of accommodating multiple trays on which devices can be placed, which is simple in construction and excellent in maintenance and installing workability and has also degree of freedom of the arrangement.

To achieve the above object, the tray accommodation unit for holding multiple trays therein according to a first aspect of the invention comprises multiple tray accommodation sections arranged in parallel with each other in a horizontal direction, each tray accommodation section having an opening at the upper portion through which multiple trays can be accommodated in a stacked state, a holding unit for holding the trays, and a moving unit for movably supporting the holding unit in horizontal and vertical directions, characterized in that the holding unit is engaged with the inside of each tray accommodation section through the opening by the moving unit.

According to the first aspect of the invention, the holding unit for holding the trays is provided to be movable horizontally and vertically by the moving unit, the trays can be conveyed between multiple tray accommodation sections each having a simple construction. Further, since the trays between multiple tray accommodation sections are conveyed by the holding unit which is supported by the moving unit so as to be movable, it is not necessary to provide other conveying unit such as a conventional elevating unit in each tray accommodation section. As a result, it is possible to restrain the increase of a manufacturing cost, to maintain the unit with ease, and to expand each tray accommodation section with ease.

The tray accommodation unit according to a second aspect of the invention is characterized in that the holding unit has gripping sections for gripping each tray from the above.

According to the second aspect of the invention, since the holding unit can grip the trays from the above by the gripping section so that the trays arranged in each tray accommodation section in a stacked state can be held from the upper stage thereof with ease.

The tray accommodation unit according to a third aspect of the invention is characterized in that the holding unit holds multiple trays in a stacked state at the same time.

According to the third aspect of the invention, since the holding unit is provided so as to hold multiple trays placed in a stacked state at a time, the trays can be efficiently held. In this case, when the plurality of trays can be held at the same time by the gripping section from the above, the holding operation is stabilized.

The tray accommodation unit according to a fourth aspect of the invention is characterized in that the moving unit comprises a vertical moving mechanism provided outside each tray accommodation section for movably supporting the holding unit in an elevating direction, a horizontal moving mechanism for movably supporting the vertical moving mechanism including the holding unit in a horizontal direction, and the tray accommodation unit further includes a groove section defined at a part of each tray accommodation section opposing at least the vertical moving mechanism along the elevating direction of the holding unit.

According to the fourth aspect of the invention, since the moving unit for movably supporting the holding unit comprises the vertical moving mechanism and horizontal moving mechanism respectively provided outside each accommodation section, and it is installed independently of the tray accommodation section. Accordingly, the construction of the tray accommodation section per se can be simplified and the tray accommodation section can be expanded with ease. Since the groove is defined at a part of the tray accommodation section opposing the vertical moving mechanism along the elevating direction of the holding unit, the moving of the holding unit is not hindered by the tray accommodation section when the holding unit is engaged in the tray accommodation section by the vertical moving mechanism.

The tray accommodation unit according to a fifth aspect of the invention is characterized in further comprising a second holding unit capable of holding trays and provided at the opening defined at the upper portion of each tray accommodation section.

According to the fifth aspect of the invention, since the second holding unit for holding the trays at the opening of the tray accommodation section, the trays can be efficiently conveyed while the trays are held by the second holding unit when the device is conveyed relative to the trays or when the trays are conveyed by the holding unit relative to the tray accommodation section.

### BRIEF DESCRIPTION OF THE DRAWINGS

FIG. 1 is a perspective view of a tray accommodation unit according to the preferred embodiment of the invention.

FIG. 2 is a perspective view of a holding unit.

FIG. 3 is a perspective view of a tray accommodation section.

FIG. 4 is a perspective view of a conventional tray accommodation unit.

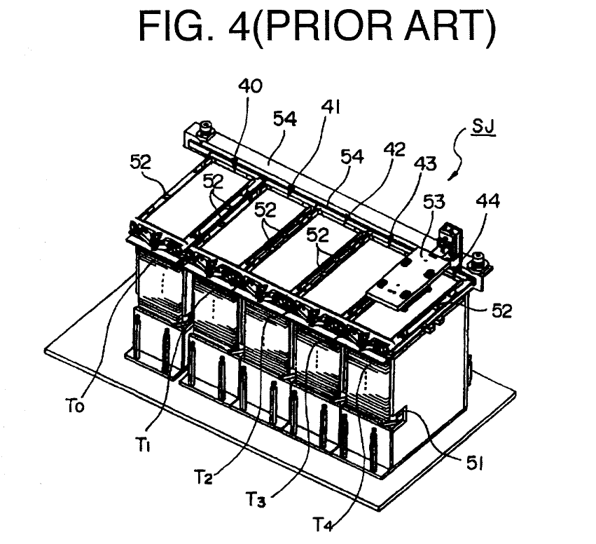

### PREFERED ENBODIMENT OF THE INVENTION

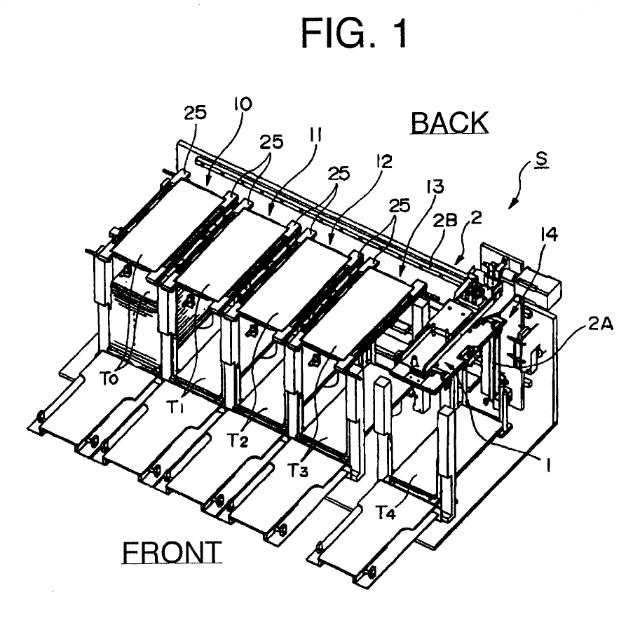

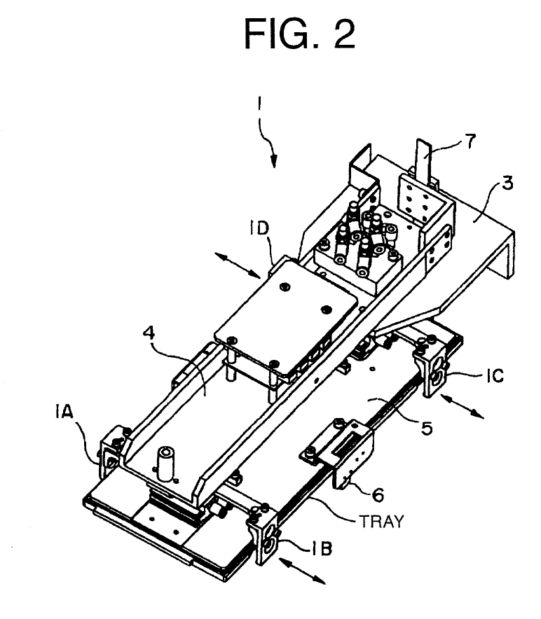

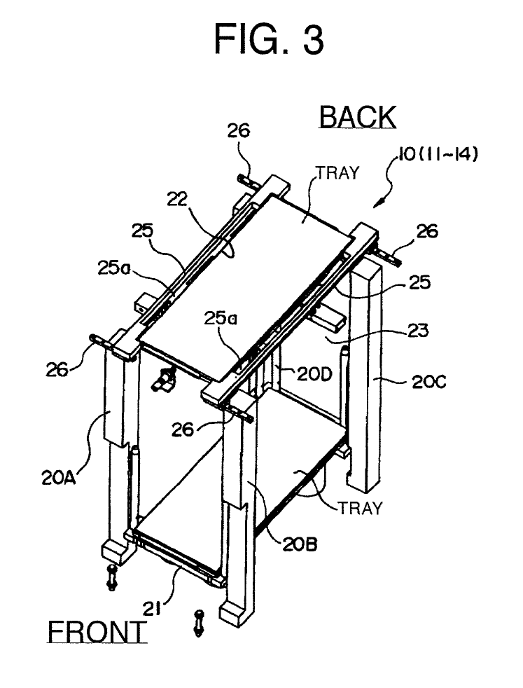

A tray accommodation unit according to the invention is described now with reference to FIGS. 1, 2 and 3. FIG. 1 is a perspective view of a tray accommodation unit according to a preferred embodiment of the invention, FIG. 2 is a perspective view of a holding unit, and FIG. 3 is a perspective view of a stocker or a tray accommodation section.

As shown in FIG. 1, a tray accommodation unit S comprises a stocker (tray accommodation section) 10 for supply purpose, a first stocker (tray accommodation section) 11, a second stocker (tray accommodation section) 12, a third stocker (tray accommodation section) 13 and a vacant stocker (tray accommodation section) 14. These multiple stockers 10, 11, 12, 13 and14 are arranged in a line horizontally, and multiple trays can be accommodated in each of these stockers in a stacked state. The trays accommodated in the stockers can place thereon devices such as ICs.

The tray accommodation unit S further comprises a holding unit 1 for holding the trays and a moving unit 2 for movably supporting the holding unit 1 in horizontal and vertical directions. The moving unit 2 comprises a vertical moving mechanism 2A for movably supporting the holding unit 1 in a vertical direction and a horizontal moving mechanism 2B for movably supporting the vertical moving mechanism 2A together with the holding unit 1 in the horizontal direction. The horizontal moving mechanism 2B is provided at the side of the stockers 10 to 14 along the arranging direction of the stockers 10 to 14. That is, the horizontal moving mechanism 2B movably supports the vertical moving mechanism 2A including the holding unit 1 along the arranging direction of the stockers 10 to 14. At that time, the moving unit 2 provided with the vertical moving mechanism 2A and the horizontal moving mechanism 2B is structured to be installed outside the stockers 10 to 14 which are arranged in a line in the horizontal direction.

As shown in FIG. 2, the holding unit 1 comprises a body section 4, a substrate section 5 provided under the body section 4 and gripping sections 1A to 1D for gripping the trays from the above. The opposed gripping sections 1A, 1B and gripping sections 1C, 1D are slidably opened or closed relative to the center of the body section 4 as shown in arrows in FIG. 2. That is, the respective gripping sections 1A to 1D are connected to the body section 4 so as to move toward or away from the end face of each tray. The holding unit 1 can hold each tray when the respective gripping sections 1A to 1D move toward the end face of each tray while the holding unit 1 releases each tray when the respective gripping sections 1A to 1D move away from the end face of each tray. A sensor 6 for detecting whether the tray is held under the substrate section 5 by the holding unit 1 is provided on the substrate section 5. A signal detected by the sensor 6 is outputted to a controller, not shown. When the respective gripping sections 1A to 1D grip the trays, the substrate section 5 and the upper surface of the trays are brought into contact with each other.

The respective gripping sections 1A to 1D can hold multiple trays in a stacked state at a time.

The holding unit 1 includes a connection section 3 to be connected to a belt 7 which is a part of the vertical moving mechanism 2A. When the belt 7 of the vertical moving mechanism 2A is moved, the connection section 3 connected to the belt 7 is moved up and down so that the respective gripping sections 1A to 1D for gripping the trays are integrally moved up and down.

As shown in FIG. 3, each of the stockers 10 to 14 has four vertical columns 20A to 20D and a bottom plate 21. The vertical columns 20A to 20D are arranged so as to surround four corners of each tray which is accommodated therein and is formed rectangularly. An opening 22 is defined at the upper portion of each of the stockers 10 to 14 provided with four vertical columns 20A to 20D. Further, front and back sides and right and left sides of each of the stockers 10 to 14 are also opened. A groove 23 defined along the elevating direction of the holding unit 1 is formed by the opening which is defined at the backside of each stocker, namely, at the portion opposing the vertical moving mechanism 2A of the moving unit 2.

A pair of chuck sections (second holding unit) 25 capable of holding each tray is provided at the opening 22 defined at each of the stockers 10 to 13. According to the preferred embodiment of the invention, no chuck section 25 is provided on the vacant stocker 14 as shown in FIG. 1. The chuck sections 25 are opened and closed in the direction to move toward or away from the end face of the tray along a chuck guide. The chuck section 25 has a groove which is defined at an L shape in cross section wherein each tray is held by this groove when the respective chuck sections 25 of the stockers 10 to 13 move toward each other, namely, when they are closed. On the other hand, each tray is released from the groove when the respective chuck sections 25 move away from each other, namely, when they are opened. Although there is a case where respective gripping sections 1A to 1D of the holding unit 1 are engaged with the chuck sections 25 in a state where the tray is held while the chuck sections 25 are closed, there are defined space sections 25a on each chuck section 25 so that the chuck sections 25 do not interfere with the gripping sections 1A to 1D even if the gripping sections 1A to 1D are engaged with the chuck sections 25. The gripping sections 1A to 1D are structured to grip the end face of each tray through the space sections 25a.

For example, each tray filled with ICs is accommodated in the stocker 10. That is, a tray T₀ on which ICs to be tested by an IC tester, not shown is accommodated in the stocker 10. Multiple trays T₀ on which the ICs are placed are accommodated inside the stocker 10 in a stacked state. The trays on which ICs which are assorted in response to the result of test by the IC tester are placed are accommodated in the first stocker 11, the second stocker 12, and the third stocker 13. That is, trays T₁, T₂ and T₃ on which the ICs assorted in response to the result of the test are accommodated in the first to third stockers 11 to 13. For example, an IC which is decided to be non-defective by an IC tester is placed on the tray T₁ of the first stocker 11 while an IC which is decided to require re-assortment is placed on the tray T₂ of the second stocker 12 and an IC which is decided to be defective by the IC tester is placed on the tray T₃ of the third stocker 13. A vacant tray T₄ on which no IC is placed is accommodated in the vacant stocker 14.

The operation of the tray accommodation unit S is described next. Described first of all is the operation for transferring an IC to be tested by an IC tester from the stocker 10. The tray T₀ on which multiple ICs are placed is accommodated inside the stocker 10 through the opening defined at the front side of the stocker 10. At this time, trays T₀ on which multiple ICs are placed are accommodated inside the stocker 10 in a stacked state. When the ICs placed on the tray T₀ inside the stocker 10 are transferred to a measuring section, the holding unit 1 is moved to the opening defined at the upper portion of the stocker 10 by the moving unit 2. The holding unit 1 is lowered by the vertical moving mechanism 2A of the moving unit 2 and engaged with the tray T₀ accommodated inside the stocker 10. At that time, the chuck sections 25 are opened.

After the holding unit 1 is engaged with the tray T₀ inside of the stocker 10, the tray T₀ which is arranged at the uppermost stage of the trays T₀ in a stacked state. That is, the tray T₀ is gripped by closing the gripping sections 1A to 1D which have been opened so far. The holding unit 1 is moved upward by the moving unit 2 in a state where the holding unit 1 grips the tray T₀. The moving unit 2 raises the holding unit 1 which grips the tray T₀ up to the chuck section 25 provided on the opening 22 defined at the upper portion of the stocker 10. At this time, the chuck sections 25 are opened.

After the holding unit 1 which holds the tray T₀ is moved up to the chuck sections 25 of the stocker 10, it delivers the tray T₀ to the chuck sections 25. That is, the chuck sections 25 are closed to hold the tray T₀. As a result, the tray T₀ on which multiple ICs are placed appears on the opening 22 defined at the upper portion of the stocker 10. A hand, not shown, transfers sequentially multiple ICs which are placed on the tray T₀ held by the chuck sections 25 of the stocker 10. During the transfer operation of the ICs by the hand, the holding unit 1 is evacuated by the moving unit 2 to a position (e.g. to the upper portion of the vacant stocker 14) remote from the stocker 10. In due time, all the ICs inside the tray T₀ are transferred by the hand so that the tray T₀ becomes vacant.

When the tray T₀ becomes vacant, the holding unit 1 which has been evacuated so far is engaged with the tray T₀ by the moving unit 2. The holding unit 1 grips the vacant tray T₀ by the gripping sections 1A to 1D. After the gripping sections 1A to 1D grip the vacant tray T₀, the chuck sections 25 are opened.

Then, the holding unit 1 lowers to the inside of the stocker 10 in a state where it holds the vacant tray T₀, then it is engaged with another tray T₀ accommodated inside the stocker 10. Another tray T₀ is filled with ICs. When the holding unit 1 holding the vacant tray T₀ is engaged with the tray T₀ which is filled with the ICs, the gripping sections 1A to ID once release the gripping of the vacant tray T₀, then, the holding unit 1 places the vacant tray T₀ over another tray T₀ which is filled with ICs.

After the vacant tray T₀ is placed over another tray T₀ which is filled with the ICs, the holding unit 1 holds these two trays T₀ at the same time. That is, the gripping sections 1A to ID of the holding unit 1 grip two trays T₀ from the above at the same time. Then, the vertical moving mechanism 2A of the moving unit 2 raises the holding unit 1 which holds two trays T₀ up to the chuck sections 25.

After the holding unit 1 which holds the two trays T₀ is moved upward up to the chuck section 25 of the stocker 10, the chuck section 25 is closed. The holding unit 1 moved upward up to the chuck section 25 releases the holding of the two trays T₀, thereby placing the two trays T₀ on the chuck sections 25. At this time, the tray T₀ which is filled with the ICs and arranged under the vacant tray T₀ of two trays T₀ is held by the chuck sections 25. In a state where the tray T₀ which is filled with the ICs is held by the chuck sections 25, the holding unit 1 is slightly moved upward by the moving unit 2, thereby holding only the vacant tray T₀ of two trays T₀ arranged on another tray T₀ of two trays T₀. A loader is engaged with another tray T₀ which is filled with the ICs and held by the chuck sections 25.

The holding unit 1 which holds the vacant tray T₀ is moved by the moving unit 2 to the vacant stocker 14. The holding unit 1 which is moved over the vacant stocker 14 is lowered by the vertical moving mechanism 2A. The holding unit 1 allows the vacant tray T₀ to accommodated inside the vacant stocker 14. At that time, if there is no tray inside the vacant stocker 14, the holding unit 1 places the vacant tray T₀ on the bottom plate 21 of the vacant stocker 14. On the other hand, if other vacant tray has been already accommodated inside the vacant stocker 14, the holding unit 1 places the vacant tray T₀ over other vacant tray which has been already accommodated in the vacant stocker 14.

The operation for assorting tested ICs placed on each tray is described now next. Described here is a step for placing ICs which are decided to be non-defective by an IC tester on a tray of the first stocker 11. A vacant tray T₁ on which ICs are to be placed is first transferred from the vacant stocker 14 to the first stocker 11. That is, the holding unit 1 is engaged with the vacant tray T₁ accommodated inside the vacant stocker 14 by the moving unit 2, so as to hold the vacant tray T₁. The holding unit 1 which holds the vacant tray T₁ is moved over the first stocker 11. After the holding unit 1 which holds the vacant tray T₁ is moved over the first stocker 11, the chuck sections 25 of the first stocker 11 are closed. After the chuck sections 25 are closed, the holding unit 1 is lowered by the vertical moving mechanism 2A of the moving unit 2, thereby delivering the vacant tray T₁ which has been held so far to the chuck sections 25 of the first stocker 11. The chuck sections 25 hold the vacant tray T₁.

After the tray T₁ is held by the chuck sections 25 of the first stocker 11, ICs which are decided to be non-defective are transferred to and placed on another tray T₁ of the chuck sections 25 of the first stocker 11 by a hand, not shown. During the transfer operation of the ICs by the hand, the holding unit 1 is evacuated by the moving unit 2 to a position away from the first stocker 11, e.g. over the vacant stocker 14. Then, another tray T₁ is filled with ICs by the hand.

After the vacant tray T₁ which is held by the chuck sections 25 of the first stocker 11 is filled with ICs, the holding unit 1 which has been evacuated so far is engaged with the first stocker 11 by the moving unit 2. At this time, the holding unit 1 is engaged with the first stocker 11 in a state where it holds the vacant tray T₁ inside the vacant stocker 14.

The holding unit 1 which is engaged with the first stocker 11 while holding the vacant tray releases the holding of the vacant tray so that the vacant tray is placed over the tray T₁ which is filled with ICs and held by each chuck sections 25 of the first stocker 11. That is, the tray T₁ which is filled with the ICs and the vacant tray are stacked on the chuck sections 25 of the first stocker 11.

After the vacant tray is placed on the tray T₁ which is filled with the ICs, the holding unit 1 is slightly lowered by the vertical moving mechanism 2A of the moving unit 2, thereby holding two trays at the same time. That is, the holding unit 1 holds two trays by the gripping sections 1A to 1D from the above at the same time.

After the holding unit 1 holds two trays, the chuck sections 25 of the first stocker 11 are opened. The holding unit 1 is lowered by the moving unit 2 to engage with the first stocker 11. Then, the holding unit 1 releases the holding of two trays which have been held so far. At that time, if there is no other tray inside the first stocker 11, the holding unit 1 places the lower tray T₁ of two trays which is filled with the ICs on the bottom section 21 of the first stocker 11. On the other hand, when other trays have been already accommodated inside the first stocker 11, the holding unit 1 places the tray T₁ which is filled with the ICs over the other trays.

After the holding unit 1 accommodates the tray T₁ of two trays which is filled with the ICs in the first stocker 11, the moving unit 2 moves the holding unit 1 slightly upward. The holding unit 1 holds only vacant trays placed over the tray T₁ which is filled with the ICs by the gripping sections 1A to 1D. The holding unit 1 which holds the vacant tray is moved upward by the moving unit 2. The moving unit 2 moves the holding unit 1 which holds the vacant tray up to the chuck sections 25 of the first stocker 11.

The holding unit 1 which is moved up to the chuck sections 25 of the first stocker 11 delivers the vacant tray which has been held so far thereby to the chuck sections 25. That is, the holding unit 1 releases the holding of the tray by the gripping sections 1A to 1D and the chuck sections 25 are closed. The chuck sections 25 hold the vacant tray. After the vacant tray is held by the chuck sections 25, tested ICs are transferred to the chuck sections 25 of the first stocker 11 by the hand in the same manner as set forth above.

The operation of the first stocker 11 for accommodating the tray T₁ which is filled with the ICs, that are decided to be non-defective, has been described so far. The operation of the second stocker 12 for accommodating therein the tray T₂ on which ICs, that are decided to require re-assortment, are placed, and the operation of the third stocker 13 for accommodating therein the tray T₃ on which ICs, that are decided to be defective, are placed are respectively the same as the operation of the first stocker 11, and hence the explanation thereof is omitted.

As mentioned in detail above, since the holding unit 1 for holding trays is provided to be movable horizontally and vertically by the moving unit 2, the trays can be conveyed between multiple stockers 10 to 14 which are simple in construction. Further, since the trays which are conveyed between multiple stockers 10 to 14 are also conveyed by the holding unit 1 which is movably supported by the moving unit 2, it is not necessary to provide other transfer unit such as a conventional elevating unit on the respective stockers 10 to 14. Accordingly, it is possible to restrain the increase of a manufacturing cost of the tray accommodation unit from being increased, and to maintain the tray accommodation unit with ease and to expand the stocker with ease, namely, to install many stockers with ease.

Since the holding unit 1 holds the tray from the above by the gripping sections 1A to 1D, it can easily hold the trays which are arranged inside the stockers 10 to 14 in a stacked state from the uppermost stage.

Since the holding unit 1 is provided with the gripping sections 1A to 1D so as to hold multiple trays in a stacked state at the same time, the ICs can be conveyed with high efficiency.

The moving unit 2 for movably supporting the holding unit 1 is structured by the vertical moving mechanism 2A and the horizontal moving mechanism 2B which are respectively provided outside the stockers 10 to 14 and independent of the stockers 10 to 14. Accordingly, the construction of the stocker per se can be simplified, thereby expanding the stocker with ease. Further, since the groove 23 is defined along the elevating direction of the holding unit 1 at a portion of the stocker opposing the vertical moving mechanism 2A, the movement of the holding unit 1 is not hindered by the stockers 10 to 14 even in a case where the holding unit 1 is engaged with the inside of each of the stockers 10 to 14 by the vertical moving mechanism 2A via the connection section 3, thereby securing the stabilized conveying operation.

Since the chuck sections 25 capable of holding trays through the openings 22 respectively defined at the stockers 10 to 13, the trays are held by the chuck sections 25 during the conveying operation of the ICs relative to the trays and during the conveying operation of the trays by the holding unit 1 relative to the stockers, thereby achieving an efficient conveying operation. According to the preferred embodiment of the present invention, although the chuck sections 25 are not provided at the vacant stocker 14 for collection purpose, it is needless to say that the chuck sections 25 are provided at the vacant stocker 14.

The gripping sections 1A to 1D of the holding unit 1 can grip multiple trays (two trays in the preferred embodiment of the invention). The sensor 6 can detect whether the gripping sections 1A to 1D grip trays by a given number (one tray or two trays). If the sensor 6 detects that the holding unit 1 does not hold the tray by a given number, the holding unit 1 is resumed to hold the tray again.

Although there are three stockers 11 to 13 are specified as a tray accommodation section for accommodating trays on which tested ICs are placed according to the preferred embodiment of the invention, the number of stockers can be arbitrarily set in response to the result of the test by an IC tester. For example, if the ICs are intended to be assorted in two kinds, namely, in non-defective ICs and defective ICs, after they are tested, two stockers are sufficient except the stocker 10 for supply purpose and the vacant stocker 14 for collection purpose. On the other hand, if the ICs are intended to be assorted in four kinds after they are tested, the stockers may be provided by an arbitrary number not more than four kinds except the stocker 10 for supply purpose and the vacant stocker 14 for collection purpose. Although the stocker 10 for supply purpose and the vacant stocker 14 for collection purpose are respectively singly provided according to the preferred embodiment of the invention, the number of such stockers can be arbitrarily set. Further, the positions of the stocker 10 for supply purpose and the vacant stocker 14 for collection purpose can be arbitrarily set by a software process.

Although the moving unit 2 provided with the vertical moving mechanism 2A and the horizontal moving mechanism 2B is disposed at the side of the stockers 10 to 14 according to the preferred embodiment of the invention, it may be disposed at the upper portion of the tray accommodation section. In this case, the holding unit 1 is movably supported by the moving unit 2 in the manner that it is moved while hung by the moving unit 2.

Although the tray T₀ on which multiple ICs to be tested are placed is carried in the stocker 10 for supply purpose through the opening defined at the front side of the stocker 10 according to the preferred embodiment of the invention, multiple tray T₀ on which multiple ICs to be tested are placed is kept at the position where the holding unit 1 can engage with the trays T₀ by the moving unit 2 so that they may be carried in the stocker 10 by the holding unit 1 through the opening 22 defined at the upper portion of the stocker 10. Likewise, when the trays T₁ to T₃ on which multiple ICs are placed are carried out from the first to third stockers, they may be carried out through the opening defined at the upper portion using the holding unit 1 which is moved by the moving unit 2 in addition to the case where they are carried out though the opening defined at the front side to the stockers 11 to 13.

As mentioned in detail above, since the holding unit for holding the trays are provided to be movable in horizontal and vertical directions by the moving unit according to the tray accommodation unit of the invention, the trays can be conveyed between multiple tray accommodation sections each having a simple construction. Further, since the trays accommodated in multiple tray accommodation sections are conveyed between the multiple tray accommodation sections by the holding unit which is movably supported by the moving unit, it is not necessary to provide other conveying unit such as a conventional elevating unit in the respective tray accommodation sections. Accordingly, it is possible to restrain the increase of a manufacturing cost of the tray accommodation unit, to maintain the tray accommodation unit with ease and to expand the tray accommodation sections with ease. Further, it is possible to provide the tray accommodation unit having the construction having a degree of freedom such that the supply and accommodation of trays are interchanged with each other by a software, serving as the improvement of productivity.

What is claimed is:

1. A tray accommodation unit for holding multiple trays therein comprising:
multiple tray accommodation sections arranged in parallel with each other in a horizontal direction, each tray accommodation section having an opening at the upper portion through which multiple trays can be accommodated in a stacked state;
a holding unit for holding the trays; and
a moving unit for movably supporting the holding unit in horizontal and vertical directions;
wherein the holding unit is engaged with the inside of each tray accommodation section through the opening by the moving unit.

2. The tray accommodation unit according to claim 1, wherein the holding unit has gripping sections for gripping each tray from the above.

3. The tray accommodation unit according to claim 1 or 2, wherein the holding unit holds multiple trays in a stacked state at the same time.

4. The tray accommodation unit according to any of claims 1 to 3, wherein the moving unit comprises:
a vertical moving mechanism provided outside each tray accommodation section for movably supporting the holding unit tin an elevating direction;
a horizontal moving mechanism for movably supporting the vertical moving mechanism including the holding unit in a horizontal direction; and
further including a groove section defined at a part of each tray accommodation section opposing at least the vertical moving mechanism along the elevating direction of the holding unit.

5. The tray accommodation unit according to any of claims 1 to 4, further comprising a second holding unit capable of holding trays and provided at the opening defined at the upper portion of each tray accommodation section.
